(19) United States
(12) Patent Application Publication
(10) Pub. No.: US 2022/0374214 A1
(43) Pub. Date: Nov. 24, 2022

(54) SYSTEM AND METHOD FOR TRANSMITTING COMMANDS AND DATA VIA NATURAL LANGUAGE-BASED FORMATS

(71) Applicant: Focus Universal Inc., Ontario, CA (US)

(72) Inventor: Desheng Wang, Diamond Bar, CA (US)

(21) Appl. No.: 17/747,805

(22) Filed: May 18, 2022

Related U.S. Application Data
(60) Provisional application No. 63/190,410, filed on May 19, 2021.

(51) Int. Cl. G06F 8/40; G06F 40/40; G06F 40/126; G06F 8/65

(52) U.S. Cl. CPC G06F 8/40; G06F 40/40; G06F 40/126; G06F 8/65

(57) ABSTRACT

Disclosed is a method for communication between two devices or between an application and the device on which the application is running. The method uses a text or natural language based syntax in the creation of a library of text language elements. An approval computing device can approve the associations of the library. The library may be transmitted to a second computing device with a message. The text language elements are converted to computer executable code by a text language module or text language application running on the device.

### CROSS-REFERENCE TO RELATED APPLICATIONS

The present application claims the benefit of priority to U.S. Provisional Patent Application No. 63/190,410, filed May 19, 2021, the disclosure of which is hereby incorporated by reference in its entirety. Any and all applications for which a foreign or domestic priority claim is identified in the Application Data Sheet as filed with the present application are hereby incorporated by reference under 37 CFR 1.57.

### FIELD

The present invention relates to a method to provide universal interoperability of devices and applications across operating systems and computer languages.

### BACKGROUND

Currently, when devices or applications are designed for use with an operating system, software is coded from scratch to allow the device or application to interoperate with the operating system. Further, the several devices may be placed on a network, and must communicate not just with one another, but with the cloud. Communication with the cloud may require additional code to interoperate with the computer language used to access the cloud. Thus, for a single device or application, thousands of lines of code in at least one language, and potentially in several computer languages, must be created for a single device or application to interoperate with, for example, a single operating system or computing environment. The requirement for thousands of lines of code is further driven by the fact that computer languages tend to have elements which are fundamental. That is, each element accomplishes little on its own, and thousands of lines of code are sometimes required even to achieve basic functions.

However, getting the device or application to simply interoperate with an operating system and the cloud is not enough. The operation must be secure, and that security must be built in to the coding. The requirement that the operation be secure means that the entirety of the created code must be examined. Almost certainly, the examiner finds portions of the code where changes must be made.

Often, when changes are made in the coding to address a first identified problem, there are unintended consequences, and a second problem, or even a third problem, is created. Of course, such iterations of coding, testing, and recoding slow progress and cost time and money. Ultimately, this makes the cost of design and testing high. For a device or system of minimum complexity it may take 3-5 years and $5 million to complete the design process. For a high complexity device or system, the design process may take 10 times longer and cost as much as 10 times more. Given the time frames involved, it is possible that the original design may be obsolete by the time it is operable. In such circumstances, no company is incentivized to innovate and design new products.

Even if the design and testing ultimately prove successful, the creation of code from scratch on a device or system meant to interoperate with a single operating system is an inefficient design process and the end product requires a significant amount of memory to store. Moreover, the code on the device or system may require updates each time the code of the operating system is updated. If the code on the device or of the application is not updated, the device or application may no longer interoperate with the operating system. The fact that a device or application may no longer interoperate is annoying for users at a minimum and may prove devastating for devices and operating systems in an industrial context. This is true because devices and applications in an industrial context may be monitoring a critical process. Because an update caused the device or application and the operating system to cease interoperating, the process may move out of tolerance, and leave those operating the system unaware.

Further, the typical state-of-the-art code may require that larger than necessary messages must be passed between a device or application and another device or application external to, or on the same device as the application. The larger the amount of data that must be passed in messages, the more processor power is used, the more network or bus resources are consumed, and the more power is consumed to operate the device or system in order to pass the excess data. Further, with large data packages, there is more chance that the data is corrupted in the transmission. It is more desirable to send compact messages for minimal use of power, and processor and network resources.

For the foregoing reasons, there is a need for a software protocol which maximizes efficiency for adding devices or applications to a device or system and more easily achieving interoperability.

### SUMMARY

A method for sending commands and data between devices is described. The method may include sending, using a first copy of a wired or wireless protocol executed by a first processor on a first device, a message carrying the one or more text language elements, from the first device to a second device. The method may further include providing, on the second device, a text language element application including a library of text language elements. The second device may further include a port for receiving the message, a second copy of the wired or wireless protocol, a second processor, and a second memory. The second device may be adapted to receive the message at the port, and may extract, using the corresponding wired or wireless protocol executed on the second processor, the one or more text language elements from the message. Using the provided text language application executed on the second processor, the second device may match the one or more text language elements to corresponding text language elements in the library of text language elements, and may translate the one or more text language elements to computer code executable on the second device.

Also described is a method for operating devices using text language syntax. The method may include sending, using a first copy of a wired or wireless protocol executed by a first processor on a first device, a message carrying the one or more text language elements, from the first device to a second device. The method may further include providing, on the second device, a text language element module including a library of text language elements. The text language module may be integrated with an operating system according to which the second device operates. The second device may further include a port for receiving the message, a second copy of the wired or wireless protocol, a second processor, and a second memory. The second device may be configured to receive the message at the port, extract, using the corresponding wired or wireless protocol executed on the second processor, the one or more text language elements from the message. The second device may use the provided text language module executed on the second processor to match the one or more text language elements to corresponding text language elements in the library of text language elements, and convert the one or more text language elements to commands to computer code executable on the second device.

Also disclosed is method for sending commands and data within a computing device.

The method may include coding a text language application including a text language element library. The text language element library may include one or more text language elements. A text language application may be added to a device. The device may include at least one processor, one or more memories, an operating system stored in the one or more memories, the operating system being executed by the at least one processor. The method may further include adding a user operated application to the device by storing it on the one or more memories. The method may still further include opening and operating the user operated application on the device. When the user operated application is opened and operated, the user operated application may send one or more text language elements to the text language application, which, using the text language application, may convert the text language elements in to code executable on the operating system.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a flowchart of the method between devices;

FIG. 2 shows a flowchart of the method within a single device; and

FIG. 3 shows a schematic of the components of the text language module or text language application.

### DETAILED DESCRIPTION

The detailed description set forth below in connection with the appended drawings is intended as a description of the presently preferred embodiment of system and method to transmit commands and data between an external device or application and a translator application on a computing device using text language protocol, and is not intended to represent the only form in which it can be developed or utilized. The description sets forth the functions for developing and operating the system in connection with the illustrated embodiments. It is to be understood, however, that the same or equivalent functions may be accomplished by different embodiments that are also intended to be encompassed within the scope of the present disclosure. It is further understood that the use of relational terms such as first, second, distal, proximal, and the like are used solely to distinguish one from another entity without necessarily requiring or implying any actual such relationship or order between such entities.

The use of text language syntax to create text language elements can greatly simplify coding requirements, thereby reducing design time and costs and maintenance costs. In this disclosure, “text language” and “natural language” may be used interchangeably and are understood to mean the same thing. Each text language element makes use of common written language words and phrases to provide syntax for computer commands and data in a logical, repeating format. By way of example and not limitation, $\DISPLAYMESSAGE {text {Lamp Connected} font{Arial} fontsize{10} color {black} background{white}} may be the syntax for a text language element. The text language elements, or natural language elements, remove barriers to communication that are typical when a human communicates with a machine through a computer language. The text language element syntax is much closer to human to human communication, but is executable by a machine.

A text language conversion protocol is required in order to create and send, or receive and process, a text language element. The text language conversion protocol can take the form of a software module or an application, as is discussed in detail below. The text language conversion protocol accomplishes two things simultaneously. First, the text language conversion protocol translates computer executable code in to the syntax of the text language element, or vice versa. Second, the text language conversion protocol either amalgamates the function of the computer code in to the much more compact text language syntax, or performs an expansion of the text language element syntax in to computer executable code.

Because text language elements are not a direct one-for-one translation of a single concept or fundamental line of code from the computer language, but rather an amalgamation of several concepts or many lines of code in the computer language, the text language elements may also be said to modularized computer executable code. Often, modules of computer executable code are meant to provide an effect or achieve some end. Similarly, an effect is often reflected in the name of the text language element, as is the case with the “DISPLAYMESSAGE” example given above.

To achieve the operation of text language elements both across and within devices, the text language conversion protocol must be embodied in a way in which the back end, or the portion of the text language computer protocol interoperating directly with the operating system, is modular. This is because, for each version of the text language conversion protocol, this portion must be at least modified, and potentially removed and replaced entirely, depending on the operating system, computer language, or general operating environment to which the version of the text language conversion protocol is keyed.

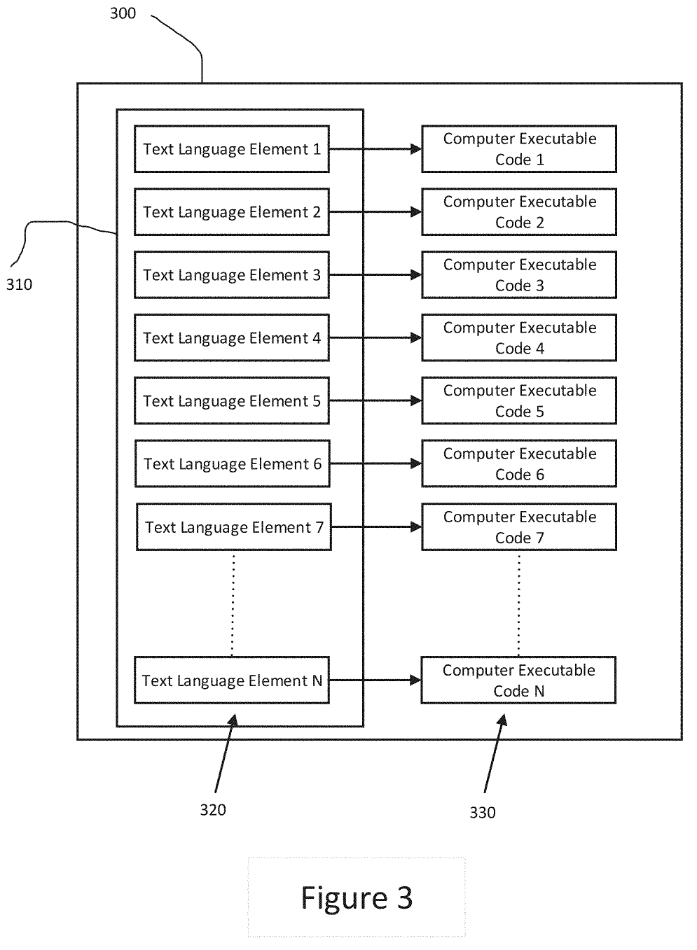

As shown in FIG. 3, the text language conversion protocol 300 may be implemented by either adding a text language module to the operating system itself, or as a separate text language application running in conjunction with, and on, the operating system. Both forms of implementation accomplish the same tasks. That is, at a minimum, they execute the text language conversion. In order to accomplish the conversion, either the module or the application includes a text language element library.

The text language element library 310 is advantageous component of the text language conversion protocol implemented as a text language module or text language application. Individual text language elements 1-N may be aggregated to form a text language element library 310. The text language element library 310 has two parts. The first part is a listing 320 of text language elements 1-N. This listing 320 of text language elements includes every text language element in existence 1 through N. The listing 320 of text language element remains consistent across all versions of the text language modules or text language applications. The second part of the text language element library 310 is computer executable code 330 which corresponds one to one with each of the text language elements 1-N. The computer executable code 330 is keyed to the operating system or computer language on which the text language module or text language application operates. The corresponding computer executable code 330 achieves the intended effect of each of the text language elements. It is this computer executable code 330 which may be removed and replaced as each version of the text language conversion protocol 300 is developed and keyed to a different operating system, computer language, or operating environment.

The text language element library 310 is both fixed and infinitely expandable. That is, the number of text language elements 1-N in the text language element library 310 at any moment in time is fixed at a given number N as shown in FIG. 3. As manufacturers or developers realize new requirements for data or command text language elements during the development of a peripheral device or an application, the corresponding text language element meeting the requirement can be created and added to the text language element library 310, as will be discussed in further detail below. In contrast to a proprietary operating system, the listing of text language elements 320 and their effects are open source, so that peripheral device manufacturers may access the listing of text language elements 320 and understand the capabilities of each of the text language elements and the text language element library 310 as a whole. A peripheral device manufacturer may take any opportunities or limitations in to account before development begins. Moreover, they can seek to close any gaps or address any needs in the text language element library 310 by developing further text language elements to aid in the operation of their device. Development of text language elements is simple compared to development of computer executable code from scratch. The developer or manufacturer may create both the new text language element, and the corresponding computer executable code for at least one operating system, computer language, or operating environment, and submit it to an approval authority. The approval authority may check the computer executable code for adverse effects, and if none are found, add the new text element and corresponding computer executable code to the appropriate version of the text language module or text language application. Based on this original, the approval authority develops computer executable code for other operating systems, computer languages, and operating environments, and publishes updates as required.

Although both may perform the functions of receiving and sending text language elements and performing the conversions as described above, the text language module or text language application on a computing device differs from the text language software on a peripheral device, or in an application on the computing device, in at least two key aspects.

First, the text language software on the peripheral device may be integrated with coding embedded on the peripheral device or application, rather than forming a stand-alone module or application. An application using text language elements has a smaller version of the text language conversion protocol embedded as part of the application's coding, as is next explained. Second, the text language software on the peripheral device or in an application only needs to have in its library the text language elements that the peripheral device or application will be sending or receiving. Typically, these natural language elements relate directly to the operation of the peripheral device or application. Thus, the number of text language elements in the text language software on a peripheral device or in an application may be limited to the functions of the device or application. For example, in the case of a peripheral device, and, specifically, a light, the text language elements may be limited to those for identification of the device, creation of a user interface on the computing device, and binary commands, for example, text language commands which turn a light off and on.

In contrast, the text language element library 310 stored in the text language conversion protocol 300 implemented as the text language module or the text language application on the computing device must include every text language element existing. This is because there is no way to determine, during the installation of the text language element library 310, which peripheral devices or application may be used with the computing device, and the software module or text language application on the computing device must therefore be prepared for each and every text language element known to exist. Further, only the text language module or text language application 300 on the computing device is updated, as described above. However, this is not a drawback, but an advantage.

When the text language module or text language application on the computing device is updated, the text language software on the peripheral device, or in an application on the same computing device, does not need a corresponding update. As discussed above, as new peripheral devices or applications are developed, a need may be generated for new text language elements. These text language elements must be validated and added to the text language library 310 on the computing device's text language module or text language application to allow interoperability with the new peripheral device or application. However, because each text language element is independent, adding new text language elements to the text language library 310 of the computing device text language module or text language application creates no requirement to change the existing text language elements. Thus, the function of existing peripheral devices or applications will be unaffected by the addition of text language elements to the library of the software module or text language application on the computing device.

Contrast this lack of required updates for peripheral devices or applications with the current state of the art, where both the operating system on the computing device and the software on the peripheral device or applications running on the computing device require contemporaneous updates in order to continue to interoperate. Again, the disclosed system allows for lowered costs, both during design and in terms of device maintenance for peripheral manufacturers. Essentially, because of the lack of required updates, there is no cost of device maintenance from a developer or manufacturer standpoint.

The computing device which is connected to the peripheral devices may be a smartphone, a tablet, a laptop, a desktop computer, or any device which runs applications or has an operating system. The computing device may be other devices, but the computing device will include one or more memories, at least one processor, and a display. As discussed above, the text language conversion protocol 300 may be implemented as a software module integrated with the operating system of the computing device. Alternatively, the text language conversion protocol 300 may be implemented as text language application stored and run on the computing device. When the text language conversion protocol 300 is in the form of a text language application, the text language application may be stored in the at least one memory on the computing device. The text language module or text language application may provide functions beyond the sending, receiving, matching, and converting to executable code based on the receipt of text language elements. These functions may be executed on the at least one processor.

The text language module or text language application communicates with other text language modules or text language applications, or embedded coding on peripheral devices or applications that performs text language element conversion. That is, a text language module on a first device or application may communication with a text language application on a second device, or any combination thereof. Alternatively, the text language module or text language application may also communicate with a text language peripheral device conversion protocol, which includes a listing of only those text language elements which are required by the peripheral device or application. In some embodiments, the text language module or text language application stored on the device is the only module/application that communicates with the operating system, computer language, and/or operating environment of the computing device. With the text language element protocol, no external messages communicate directly with the device. Text language elements only communicate indirectly. The text language elements do so through the text language module or text language application, and then only when the incoming text language element finds a match in the text language element library. Thus, the use of text language elements allows for greater security of devices and applications. Not only are potentially harmful incoming messages or code stopped, either because the text language element is not matched in the text language element library or because any malicious code is eliminated by the approval authority before any update, but also the code that operates the device may be maintained as proprietary. When text language elements are used, the coding used to operate the device is irrelevant to the interoperability of the device or application. Interoperability is achieved through the exchange of text language elements. The code that operates the device remains secure behind the text language element module or text language application, which effectively acts as a firewall.

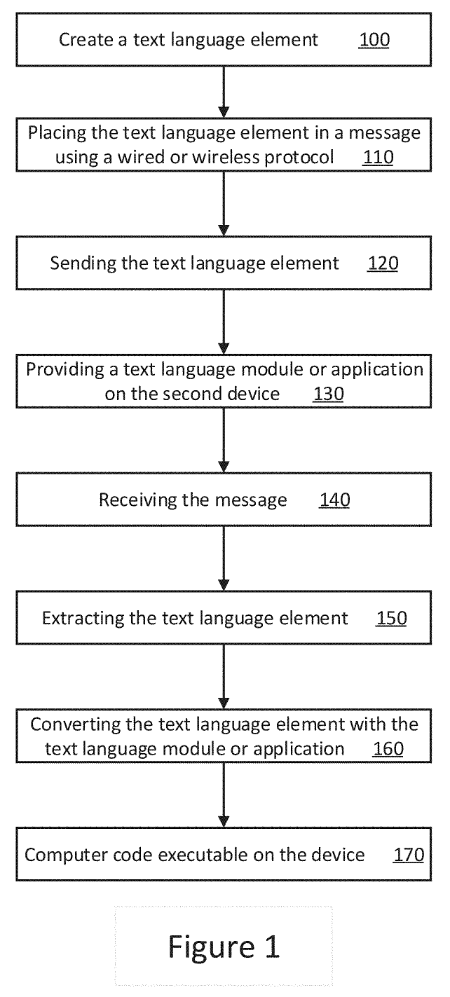

An example of the operation of the text language elements and text language conversion protocol will now be described. This embodiment is understood to be only exemplary to provide an understanding the operation of the text language elements and text language conversion protocol, and is not meant to be limiting. By way of example and not limitation, a first device may send a text language element to direct a second device to display a message on a display of the second device. The message may say “lamp connected.” As shown in FIG. 1, in Step 100, based on code running on the first device, the text language module or text language application may generate or create the text language element: $\DISPLAYMESSAGE {\text {Lamp Connected} font{Arial} fontsize{10} color {black} background{white}}. This text language element includes both command and data components. Specifically, the overall text language element is a command, specifically “DISPLAYMESSAGE.” Then, the text language element includes a number of data sub-components which provide parameters regarding the message to be displayed. These are data elements. The text of the message is specified as “Lamp Connected.” The font and font size for the text “Lamp Connected” are specified as “Arial” and “10.” Finally, the color of the lettering “black” and the color of the background bubble “white” are specified. It is to be understood that such a text language element could depart from the exact format above without departing from the spirit of the disclosure. The exact syntax does not lie at the heart of the disclosure, rather, it is the use of natural or text language to identify each of the elements and the sub components of the elements. For example, instead of braces, parentheses may be used. Alternatively, or in addition, there may be more or fewer symbols placed first in the syntax, before the main identifier of the text language element.

Alternatively, less customization could be allowed for the text language element “DISPLAYMESSAGE.” Black text and white background may be mandated with only font and font size being customizable aspects of the chosen text. Thus, the text language element would be altered to “$\DISPLAYMESSAGE {text {Lamp Connected} font{Arial} fontsize{10}}.” The elements can use descriptive text in each of the text language elements, for the name of the element itself and/or for the components of the element.

As the text language element conversion protocol does not include an integrated protocol for transmission, in Step 110 text language elements may be packaged in a wired or wireless protocol and sent externally in the wired or wireless protocol as data. The process of packaging data in a wired or wireless protocol for sending on a network is well known in the art. The first device sends packets with the text language elements in the data portion of the wireless or wired protocol to the second device. The second device may send an acknowledgement to the first device that the message was received. Most wired or wireless protocols include bilateral communication, so the first device also receives signals sent from the second device. It is understood that one device may receive from or send signals or messages to, more than one device. The signals or messages may be sent via wired or wireless connections. In addition, in one embodiment, the first device may send the signals directly to the second device. In other embodiments, the signal may pass through one or more intermediate devices. These intermediate devices may include devices incorporating a router. These intermediate devices may only be a router, or may perform functions beyond those of a router, while still incorporating router functions. For example, an intermediate device may perform both device management and router functions.

Wireless protocols may include Bluetooth or WIFI connections using a TCP/IP protocol, and the wired protocols may include a local area network of ethernet cable using TCP/IP or other protocols, for example universal powerline bus over structural electrical wiring, or similar powerline communication protocols.

In Step 130, the second device has a text language conversion protocol implemented on it, in the form of a text language module or text language application. As shown in Step 140, the second device, using the the wired or wireless protocol, receives the message. The wired or wireless protocol then, as in shown in Step 150, extracts the text language element and delivers the data within the device. By way of example and not limitation, the TCP protocol may deliver the data contained within a message, in this case, the text language element “DISPLAY MESSAGE” to the text language module or text language application on the second device. In Step 160, the text language module or text language application on the second device receives the text language element “DISPLAY MESSAGE,” and, using the library, attempts to find a match. If a match is found, the text language module or text language application determines the computer executable code corresponding to the text language element “DISPLAY MESSAGE.” If no match is found, then nothing may occur.

As shown in Step 170, once a match is found, the text language element is converted in to computer executable code. Depending on the operating system, computing language in use, or the computing environment, the computer executable code may take any number of forms. However, the effect of the computer executable code remains consistent. A message saying “Lamp Connected” in black Arial 10-point font inside a white dialog bubble is displayed on the display of the computing device for some period of time. The period of time may be specified in the executable code based on the parameter of the “DISPLAYMESSAGE” text language element. Alternatively, the length of time the message is displayed may be a user specifiable parameter in the text language element.

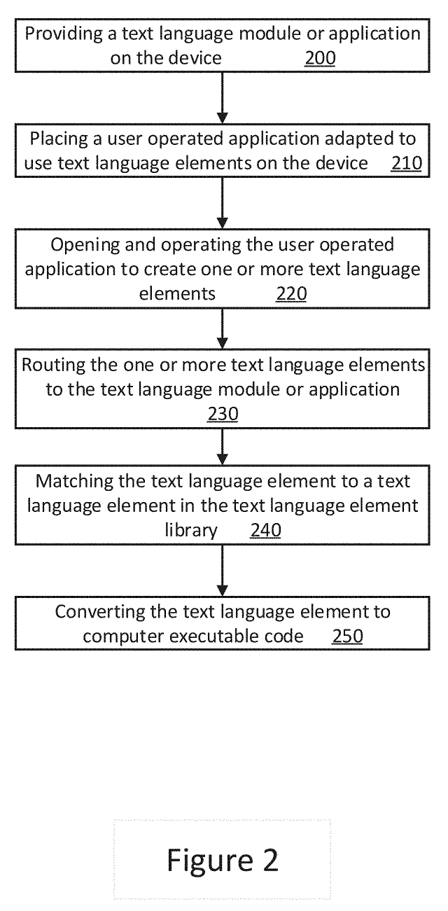

As shown in FIG. 2, just as text language elements may be used to send commands and data between devices, as in the embodiment above, text language elements may also be used to send commands and data within a single device. Specifically, the text language elements may be used by an application running on the device, as shown in Step 210. Of course, in order for the text language elements to be converted in to computer executable code, a text language conversion protocol must be implemented in the form of a text language module or a text language application on the device, as shown in Step 200. When used within a single device, the application on the device may opened and operated to generate one or more text language elements, as is shown in Step 220. These generated one or more text language elements, which may include commands, or data, or both, can be routed external of the application and within the device to the the text language module or text language application, as shown in Step 230. The operation of the text language module or text language application is the same as described above. That is, in part, after matching a text language element to one in the text language element library, the text language element is converted in to the corresponding computer executable code, as is shown in Steps 240 and 250, respectively. Essentially, the text language elements may be used as a coding shortcut because of their amalgamation of more basic computer code through the conversion in to text language element syntax. Again, because of the compact nature of the text language syntax, the coding required for the application may be greatly reduced, allowing faster development of applications.

Developers of applications which use text language elements can be assured that such functions will have their intended effect across operating systems and in operation with code in any of a number of computer languages. Thus, not only may a first product for use on a first operating system be quickly developed, but it is possible with the use of text language elements that the first product will function across a number of operating systems. Thus, when using text language elements to code application there is no need to port the code from operating system to operating system. In the state of the art, an application may come out compatible with a single operating system. Consumers regularly using operating systems other than that for which an application was initially developed are forced to wait for a version of the application compatible with that different operating system to be developed. Sometimes, it is never developed. With the use of text language elements, the same version of an application will work across operating systems.

The text language elements provide a truncated learning curve due to their close relationship to their spoken or written word counterparts, and because there is no need to learn fundamental concepts which only relate to the operation of computers. Instead, a user may begin by using text language elements almost immediately. Even a non-software engineer can become comfortable with the protocol in a limited period of time. This means that the development process for device manufacturers and application coders is similarly truncated. This allows at least some developers or manufacturers who could not previously afford the expensive and tedious traditional development process, including drafting thousands upon thousands of lines of computer code, which may or may not function properly when completed, to enter the market.

The text or natural language elements may be directed to commands or data, or both. As noted above, the syntax of each of the text or natural language elements is largely composed of words used in the manner they would typically be used in the written language from which they are derived.

By way of example and not limitation, a second example will be discussed which clearly illustrates the ability of text language elements to accomplish commands with the use of data, or to send solely either a command or data. The text language module or text language application may facilitate the near real-time creation of a custom user interface, which allows a user to control the devices connected to the computing device. The creation of the user interface is done using text language elements as well.

The following text language elements may be used in the creation of a user interface. The text language element “$\BACKCOLOR {color{royalblue}}” may be sent to establish a background color for a screen of the user interface. In this case, the background, or wallpaper, color would be royal blue. The text language element “$\RADIOBUTTON {labeltext{On/Off} size {12} font{Arial} fontcolor {white} location{20,40}}” may be sent to create a radio button on the screen. The radio button may have the text “On/Off” in size 12 Arial font in the color white. The radio button would be located at the location 20, 40 on the screen.

The user interface described above may allow the user to control one or more features of the connected peripheral device or devices. Such control would be accomplished by providing control surfaces on the user interface. The radio button described above may be one such control surface. The user interface may have one or more control surfaces. The manipulation of the control surfaces either directly or indirectly (through the text language module or text language application) generates text language elements which are sent to either a peripheral device or to the computing device, depending on the function indicated on the user interface. The peripheral device unpackages the data, in this case one or more text language elements, or the computing device receives the text language element, and determines, based on the text language elements, the corresponding computer executable code as described above. In the case of the creation of a user interface, there may be both command text language elements and data text language elements. The command text language elements may include data sub-components.

Once the user interface is established, a user may exercise control over the peripheral device via the control surfaces provided on the screen for the peripheral device in the user interface. A user may manipulate these control surfaces on the computing device. For example, in the case of a radio button, the user may choose to toggle the state of the device from off to on. This manipulation by the user in turn generates a command in the operational protocol of the computing device that is passed to the text language module or text language application on the computing device for conversion in to a text language element. For example, the text language element might be “$\LIGHTON {state{1}}” or “$\LIGHTOFF {state {0}}.” The text language element is then sent to the peripheral device where the text language element is converted in to code executable on the peripheral device, and the light is turned on or off.

In some embodiments, text language elements can be used even more fundamentally, specifically, as a programming language unto themselves. As with the exemplary embodiments discussed above, the use of text language elements allows for a much shorter learning curve. Because applications unto themselves do not require hardware design, such applications may be coded using far fewer resources than comparable applications programmed using state-of-the-art. Each element of the text language element is intuitive, and given the breadth of the library, many commands may be used and data may be passed, allowing many common functions to be performed. Gaps may be covered either by adding text language elements to the library or by coding in known computer languages for bridge the gaps. The individual facts and circumstances may dictate one choice or the other.

### EXAMPLE EMBODIMENTS

Below is a list of nonlimiting examples of implementations of the description above.

In a 1st Example, a method for sending commands and data between devices, comprising: creating one or more text language elements on a first device by converting computer executable code in to the one or more text language elements; sending, using a first copy of a wired or wireless protocol executed by a first processor on a first device, a message carrying the one or more text language elements, from the first device to a second device; and providing, on the second device, a text language element application including a library of text language elements, the second device further including a port for receiving the message, a second copy of the wired or wireless protocol, a second processor, and a second memory; the second device being adapted to receive the message at the port, extract, using the corresponding wired or wireless protocol executed on the second processor, the one or more text language elements from the message, and, using the provided text language application executed on the second processor, match the one or more text language elements to corresponding text language elements in the library of text language elements, and translate the one or more text language elements to computer code executable on the second device.

In a 2nd Example, the method of Example 1, wherein the second device transmits commands to operate the first device using text language elements.

In a 3rd Example, the method of Example 2, wherein the first device includes embedding coding which translates the text language elements.

In a 4th Example, the method of Example 3, wherein the embedded coding executes the translated commands.

In a 5th Example, the method of any of Examples 1-4, wherein the text language element application beings operating when the second device is powered on.

In a 6th Example, the method of any of Examples 1-5, wherein the library of text language elements is expandable.

In a 7th Example, the method of any of Examples 1-6, wherein the peripheral device and the computing device exchange messages using the TCP/IP protocol.

In an 8th Example, a method for operating devices using text language syntax, comprising: creating one or more text language elements on a first device by converting computer executable code in to the one or more text language elements; sending, using a first copy of a wired or wireless protocol executed by a first processor on a first device, a message carrying the one or more text language elements, from the first device to a second device; and providing, on the second device, a text language module including a library of text language elements, the text language module being integrated with an operating system according to which the second device operates; the second device further including a port for receiving the message, a second copy of the wired or wireless protocol, a second processor, and a second memory; the second device being configured to receive the message at the port, extract, using the corresponding wired or wireless protocol executed on the second processor, the one or more text language elements from the message, and, using the provided text language module executed on the second processor, matching the one or more text language elements to corresponding text language elements in the library of text language elements, and convert the one or more text language elements to commands to computer code executable on the second device.

In a 9th Example, the system of Example 8, wherein the text language element module further includes executable computer code corresponding to each of the text language elements in the library.

In a 10th Example, the system of any of Examples 8-9, wherein the first device and the second device exchange messages using the TCP/IP protocol.

In a 11th Example, the system of Example 10, wherein the text language element includes a command.

In a 12th Example, the system of any of Examples 8-11, wherein the text language element includes both commands and data.

In a 13th Example, a method for sending commands and data within a computing device, comprising: coding a text language application including a text language element library, the text language element library including one or more text language elements; adding a text language application to a device, the device including at least one processor, one or more memories, an operating system stored in the one or more memories, the operating system being executed by the at least one processor; adding a user operated application to the device by storing it on the one or more memories; and opening and operating the user operated application on the device; wherein, when the user operated application is opened and operated, the user operated application sends one or more text language elements to the text language application, which, using the text language application, converts the text language elements in to code executable on the operating system.

In a 14th Example, the system of Example 13, wherein the one or more text language elements include commands.

In a 15th Example, the system of any of Examples 13-14, wherein the one or more text language elements include data.

In a 16th Example, the system of Example 15, wherein the one or more text language elements include commands.

In a 17th Example, the system of any of Examples 13-16, wherein the text language element library includes computer executable code stored in a one to one correspondence with each of the one or more text language elements.

In a 18th Example, the system of any of Examples 13-17, wherein the device is a mobile device.

In a 19th Example, the system of any of Examples 13-18, wherein the device is a desktop computer.

In a 20th Example, the system of any of Examples 13-19, wherein the text language application may be updated by adding an updated text language element and computer executable code in a one to one correspondence with the updated text language element to the text language element library.

### OTHER CONSIDERATIONS

The above description is given by way of example, and not limitation. Given the above disclosure, one skilled in the art could devise variations that are within the scope and spirit of the invention disclosed herein, including various ways of forming the syntax of the text or natural language commands. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for sending commands and data between devices, the method comprising:
creating, using a first computing device, a library comprising first and second pluralities of text language elements and corresponding associations of computer executable code for each of the text language elements;
sending, from the first computing device to an approval computing device, a message comprising the library of the pluralities of text language elements;
receiving, from the approval computing device, approval of the associations of the library;
determining that the first, but not the second, plurality of text language elements corresponds to a second computing device;
transmitting, based on the approval of the associates of the library and on the determining that the first, but not the second, plurality of text language elements corresponds to the second computing device, a message comprising the first plurality of associations of the library to a second computing device;
receiving, at the second computing device, the message and the library of associations;
extracting, at the second computing device, the first plurality of text language elements from the message;
translating, based on the first plurality of associations of the library, each of the first plurality of text language elements into the associated computer executable code; and
executing, at the second computing device, the computer executable code associated with each of the first plurality of text language elements.

2. The method of claim 1, wherein the second computing device transmits commands to operate the first computing device using the first plurality of text language elements.

3. The method of claim 2, further comprising:
associating, using the first computing device, the computer executable code for each of the text language elements.

4. The method of claim 3, wherein the associations are configured to allow for execution of the translated commands.

5. The method of claim 1, wherein the first and second computing devices are coupled to the same network.

6. The method of claim 5, wherein the library of text language elements is expandable.

7. The method of claim 1, wherein the second computing device and the first computing device exchange messages using the TCP/IP protocol.

8. A method for operating devices using text language syntax, the method comprising:
creating one or more text language elements on a first computing device by converting computer executable code in to the one or more text language elements;
sending, using a first copy of a wired or wireless protocol executed by a first processor on a first computing device, a message carrying the one or more text language elements, from the first computing device to a second computing device; and
providing, on the second computing device, a text language module including a library of text language elements, the text language module being integrated with an operating system according to which the second computing device operates; the second computing device further including a port for receiving the message, a second copy of the wired or wireless protocol, a second processor, and a second memory;
the second computing device being configured to receive the message at the port, extract, using the corresponding copy of the wired or wireless protocol executed on the second processor, the one or more text language elements from the message, and, using the provided text language module executed on the second processor, matching the one or more text language elements to corresponding text language elements in the library of the text language elements, and convert the one or more text language elements to commands to computer code executable on the second computing device.

9. The method of claim 8, wherein the text language module further includes executable computer code corresponding to each of the text language elements in the library.

10. The method of claim 8, wherein the first computing device and the second computing device exchange messages using the TCP/IP protocol.

11. The method of claim 10, wherein the text language element includes a command.

12. The method of claim 8, wherein the text language element includes both commands and data.

13. A method for sending commands and data within a computing device, the method comprising:
coding a text language application including a text language element library, the text language element library including one or more text language elements;
adding a text language application to a device, the device including at least one processor, one or more memories, an operating system stored in the one or more memories, the operating system being executed by the at least one processor;
adding a user operated application to the device by storing it on the one or more memories; and
opening and operating the user operated application on the device;
wherein, when the user operated application is opened and operated, the user operated application sends one or more text language elements to the text language application, which, using the text language application, converts the text language elements in to code executable on the operating system.

14. The method of claim 13, wherein the one or more text language elements include commands.

15. The method of claim 13, wherein the one or more text language elements include data.

16. The method of claim 15, wherein the one or more text language elements include commands.

17. The method of claim 13, wherein the text language element library includes computer executable code stored in a one to one correspondence with each of the one or more text language elements.

18. The method of claim 13, wherein the device is a mobile device.

19. The method of claim 13, wherein the device is a desktop computer.

20. The method of claim 13, wherein the text language application may be updated by adding an updated text language element and computer executable code in a one to one correspondence with the updated text language element to the text language element library.
